(19) United States
(12) Patent Application Publication
(10) Pub. No.: US 2025/0111567 A1
(43) Pub. Date: Apr. 3, 2025

(54) IMAGE PROCESSING APPARATUS, IMAGE PROCESSING METHOD, PROGRAM, AND RECORDING MEDIUM

(71) Applicant: FUJIFILM Corporation, Tokyo (JP)

(72) Inventors: Yuya NISHIO, Saitama (JP); Masaru KOBAYASHI, Saitama (JP); Kei YAMAJI, Saitama (JP); Kazuya OKIYAMA, Saitama (JP); Toshiki KOBAYASHI, Saitama (JP)

(73) Assignee: FUJIFILM Corporation, Tokyo (JP)

(21) Appl. No.: 18/893,871

(22) Filed: Sep. 23, 2024

(30) Foreign Application Priority Data
Sep. 28, 2023 (JP) 2023-166741

(51) Int. Cl. G06T 11/60

(52) U.S. Cl. CPC G06T 11/60

(57) ABSTRACT

Provided are an image processing apparatus, an image processing method, a program, and a recording medium capable of outputting an image in which a text related to an input image is appropriately disposed in consideration of a subject in the input image.

An image processing apparatus according to one embodiment of the present invention includes a processor, in which the processor is configured to execute processing of acquiring a text related to the input image, processing of specifying a first subject corresponding to the text from a subject included in the input image, and processing of deciding a disposition of the text in an output image based on the input image according to the input image and the first subject.

### CROSS-REFERENCE TO RELATED APPLICATIONS

The present application claims priority under 35 U.S.C. § 119 to Japanese Patent Application No. 2023-166741, filed on Sep. 28, 2023. The above application is hereby expressly incorporated by reference, in its entirety, into the present application.

### BACKGROUND OF THE INVENTION

### 1. Field of the Invention

One embodiment of the present invention relates to an image processing apparatus, an image processing method, a program, and a recording medium capable of outputting an output image to which a text is assigned to an input image.

### 2. Description of the Related Art

As a technique of using an image, a technique of assigning a text according to a subject in the image is already known. An example thereof includes the technique disclosed in JP2017-229102A. In the technique disclosed in JP2017-229102A, a captured image is analyzed to generate text information, the captured image is processed based on the text information, and the text information is assigned to the processed image. Accordingly, it is possible to display a comment based on the captured image and the image at the same time and improve matching feeling of the comment and the image.

### SUMMARY OF THE INVENTION

In a case where a text is assigned to an image using the technique disclosed in JP2017-229102A, the text needs to be disposed at an appropriate position in the image. In particular, in a case where a text according to a subject in the image is assigned, there is a concern that an effect of assigning the text may not be appropriately obtained in a case where the disposition of the text is decided without considering a relationship between the subject and the text. On the other hand, in a case where a user tries to decide the disposition of the text in consideration of the subject, the work takes time and effort.

One embodiment of the present invention has been made in view of the above circumstances, and an object thereof is to provide an image processing apparatus, an image processing method, a program, and a recording medium capable of outputting an image in which a text related to an input image is disposed at an appropriate position in consideration of a subject in the input image.

The above object is achieved by an image processing apparatus according to any one of [1] to [16].
[1] An image processing apparatus that processes an input image, the image processing apparatus comprising a processor, in which the processor is configured to execute processing of acquiring a text related to the input image, processing of specifying a first subject corresponding to the text from a subject included in the input image, and processing of deciding a disposition of the text in an output image based on the input image according to the input image and the first subject.
[2] The image processing apparatus according to [1], in which the processor is configured to acquire the text based on an input operation of a user.
[3] The image processing apparatus according to [1] or [2], in which the processor is configured to generate the text based on a region selected by a user in the input image.
[4] The image processing apparatus according to any one of [1] to [3], in which the processor is configured to generate the text based on an analysis result of the input image.
[5] The image processing apparatus according to any one of [1] to [4], in which the processor is configured to generate the text based on accessory information of the input image.
[6] The image processing apparatus according to any one of [1] to [5], in which the processor is configured to decide the disposition in which the text does not overlap the first subject.
[7] The image processing apparatus according to any one of [1] to [6], in which the processor is configured to decide the disposition in which the text does not overlap a specific portion of the first subject.
[8] The image processing apparatus according to any one of [1] to [7], in which, in a case where the output image including the input image and the text is output, the processor is configured to decide the disposition in which the text does not overlap the first subject and a second subject different from the first subject in the input image, in a periphery of the first subject.
[9] The image processing apparatus according to any one of [1] to [8], in which, in a case where a plurality of texts are acquired as the text, the processor is configured to decide the disposition of the plurality of texts in which the texts do not overlap each other in a periphery of the first subject.
[10] The image processing apparatus according to any one of [1] to [9], in which, in a case where the output image including the input image having an image region and a margin region and the text is output, the processor is configured to decide the disposition in at least one of the image region or the margin region of the input image included in the output image.
[11] The image processing apparatus according to any one of [1] to [10], in which, in a case where the output image including the input image and the text is output, the processor is configured to generate a margin region in at least a part of a periphery of the input image in the output image, and decide the disposition of the input image and the text in the output image.
[12] The image processing apparatus according to any one of [1] to [11], in which the processor is configured to acquire evaluation values related to the dispositions for a plurality of regions in the input image based on the input image, and decide the dispositions based on the evaluation values of the plurality of regions.
[13] The image processing apparatus according to any one of [1] to [12], in which the processor is configured to acquire a plurality of texts as the text, and decide the disposition for the plurality of texts.
[14] The image processing apparatus according to any one of [1] to [13], in which the processor is configured to divide the text into a plurality of texts, and decide the disposition for the plurality of texts.
[15] The image processing apparatus according to any one of [1] to [14], in which the processor is configured to acquire a plurality of input images as the input image, and generate the text related to at least one of the plurality of input images based on analysis results of the plurality of input images.
[16] The image processing apparatus according to any one of [1] to [15], in which, in a case where the output image including the input image having an image region and a margin region and the text is output, the processor is configured to determine whether or not the disposition is capable of being decided in the margin region in the input image based on the text, change a layout of the image region in the input image in a case where the disposition is determined to be incapable of being decided in the margin region in the input image, and decide the disposition in the margin region in the output image including the input image whose layout is changed.

Further, the above object can be achieved by the following image processing method according to any one of [17] to [19].
[17] An image processing method of processing an input image by a processor, the image processing method comprising, by the processor, a step of acquiring a text related to the input image, a step of specifying a first subject corresponding to the text from a subject included in the input image, and a step of deciding a disposition of the text in an output image based on the input image according to the input image and the first subject.
[18] The image processing method according to [17], in which, in the step of acquiring the text, the text is generated based on an analysis result of the input image, by the processor.
[19] The image processing method according to [18], further comprising a step of assigning evaluation values related to the dispositions to a plurality of regions in the input image by the processor, in which, in the step of deciding the disposition, the disposition is decided based on the evaluation values of the plurality of regions by the processor.

Further, a program according to one embodiment of the present invention is a program for causing a computer to execute each of the steps included in the image processing method described in any one of [17] to [19] above.

Further, a recording medium according to one embodiment of the present invention is a computer-readable recording medium on which a program for causing a computer to execute each of the steps included in the image processing method described in any one of [17] to [19] above is recorded.

According to one embodiment of the present invention, there are provided the image processing apparatus, the image processing method, the program, and the recording medium capable of outputting the image to which the text related to the input image is assigned to an appropriate position in consideration of the subject in the input image.

### BRIEF DESCRIPTION OF THE DRAWINGS

FIG. 1 is a diagram showing a use example of an image processing apparatus according to a first embodiment of the present invention.

FIG. 2 is a diagram showing a procedure from acquisition of an input image to output of an output image.

FIG. 3 is a diagram showing a hardware configuration of the image processing apparatus according to the first embodiment of the present invention.

FIG. 4 is a diagram for describing a function of the image processing apparatus according to the first embodiment of the present invention.

FIG. 5A is a diagram showing a first example of the output image according to the first embodiment of the present invention.

FIG. 5B is a diagram showing a second example of the output image according to the first embodiment of the present invention.

FIG. 5C is a diagram showing a third example of the output image according to the first embodiment of the present invention.

FIG. 6 is a diagram showing an example of an image processing flow according to the first embodiment of the present invention.

FIG. 7 is a diagram for describing a modification example of the first embodiment of the present invention.

FIG. 8 is a diagram for describing another modification example of the first embodiment of the present invention.

FIG. 9 is a diagram showing a use example of an image processing apparatus according to a second embodiment of the present invention.

FIG. 10 is a diagram showing a use example of an image processing apparatus according to a third embodiment of the present invention.

FIG. 11 is a diagram showing the input image and the output image according to the third embodiment of the present invention.

FIG. 12 is a diagram for describing a function of the image processing apparatus according to the third embodiment of the present invention.

FIG. 13 is a diagram for describing a layout change of the image.

FIG. 14 is a diagram showing a modification example of the output image.

### DESCRIPTION OF THE PREFERRED EMBODIMENTS

Hereinafter, specific embodiments of the present invention will be described.

In the following, for convenience of description, the description may be made in terms of a graphic user interface (GUI). Further, since basic data processing techniques (communication/transmission techniques, data acquisition techniques, data recording techniques, data processing/analysis techniques, machine learning techniques, image processing techniques, visualization techniques, and the like) for implementing the present invention are well-known techniques, the description thereof will be omitted.

Further, in the present specification, the concept of “apparatus” includes a single apparatus that exerts a specific function, and includes a combination of a plurality of apparatuses that exert a specific function in cooperation (coordination) with each other while being distributed and present independently of each other.

Further, in the present specification, a term “user” is a user of the image processing apparatus according to the embodiment of the present invention, and specifically, for example, a person who uses an output Image described below obtained by the function of the image processing apparatus according to the embodiment of the present invention.

Further, in the present specification, the term “person” means a main subject that performs specific behavior, may include an individual, a group, a corporation, such as a company, an organization, and the like, and may also further include a computer and a device that constitute artificial intelligence (AI). The artificial intelligence realizes intellectual functions, such as reasoning, prediction, and determination, by using a hardware resource and a software resource. An algorithm of the artificial intelligence is random, and examples thereof include an expert system, a case-based reasoning (CBR), a Bayesian network, or an inclusion architecture.

### First Embodiment of Present Invention

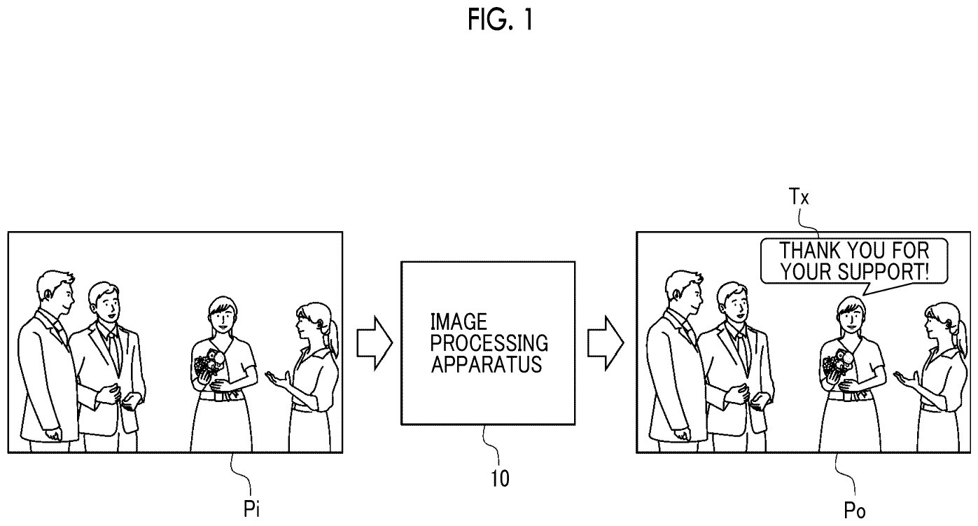

In a first embodiment of the present invention (hereinafter referred to as first embodiment), as shown in FIG. 1, an image processing apparatus according to the embodiment of the present invention assigns a text to an image input to the image processing apparatus (hereinafter referred to as input image Pi), and outputs an image including the input image and the text (hereinafter referred to as output image Po). The user can use the output image Po.

The assignment (disposition) of the text in the image means that the text is converted into an image (text image) and included in the output image as a part of the output image.

The term “image” in the present invention is configured of a plurality of pixels, is expressed by a gradation value of each of the plurality of pixels, and includes at least one or more subjects. Further, digital image data (hereinafter image data) in which an image is defined at a set resolution is generated by compressing data in which the gradation value for each pixel is recorded by a predetermined compression method. Examples of a type of the image data include irreversible compressed image data, such as joint photographic experts group (JPEG) format, and reversible compressed image data, such as graphics interchange format (GIF) or portable network graphics (PNG) format.

In the first embodiment, a method of inputting the image is not particularly limited. For example, the method thereof includes inputting image data of the image captured by an imaging device such as a camera, and inputting reading data obtained by reading an existing photograph with a scanner or the like. Further, in a case where the imaging device is mounted on the image processing apparatus, the imaging device may capture the image and acquire the image data to input the image. Further, the image data may be downloaded from an external device, a web server, or the like via a communication network to input the image.

Further, the input image Pi may be a developed image obtained by developing a RAW image, a correction image subjected to predetermined correction processing on the developed image, or an edited image subjected to an editing process on the developed image or the correction image.

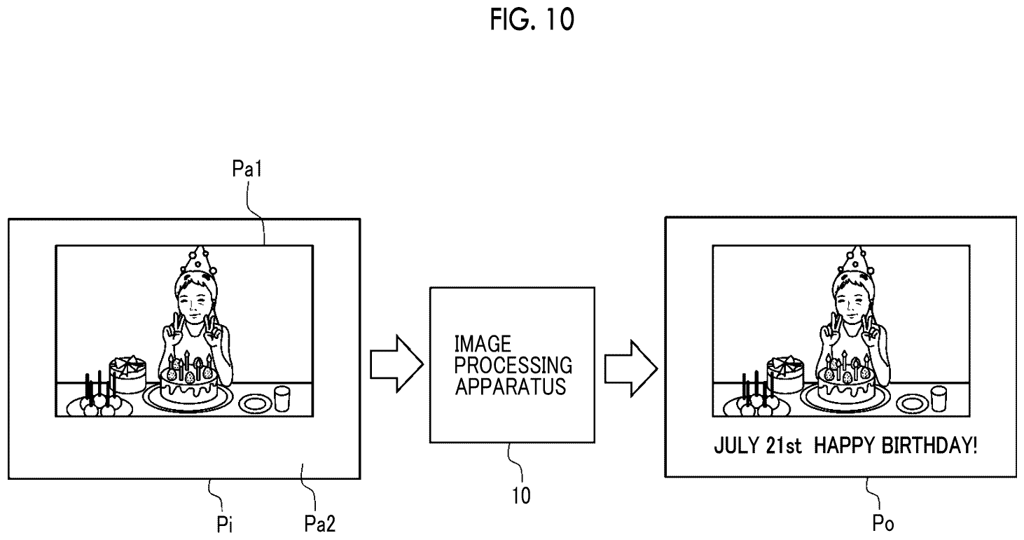

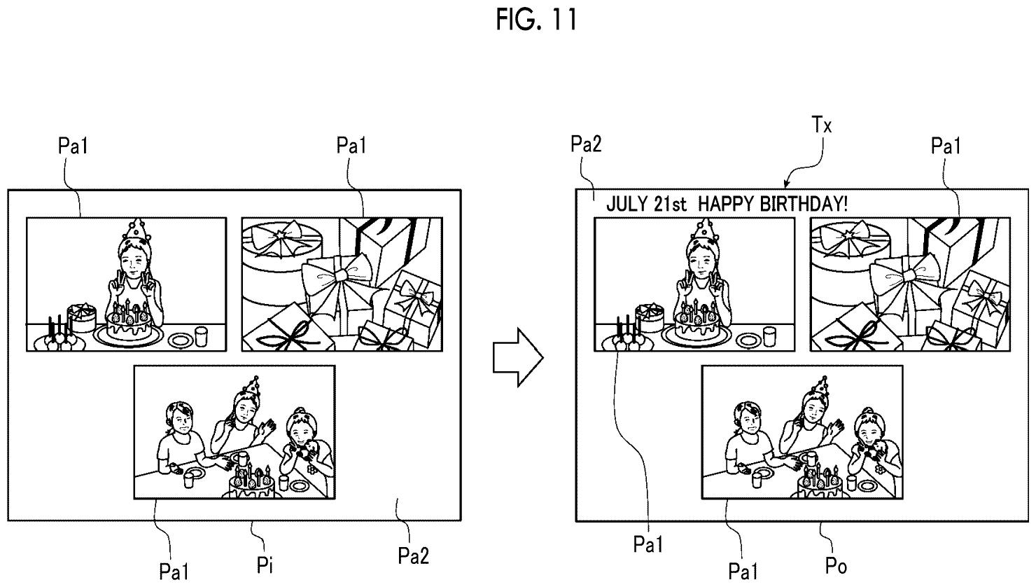

The edited image as the input image may be an image configured by disposing one or a plurality of images in a predetermined layout (refer to FIGS. 10 and 11). That is, the input image Pi may be an image including one or more image regions and a margin region other than the image regions. The image region is, for example, a region including the subject, and the margin region is a region not including the subject. Regions including a design, a drawing pattern, a pattern, an illustration, and another decorative object may be regarded as the margin region as long as, for example, a text can be written in the region.

In the first embodiment, a method of outputting the image is not particularly limited. For example, the method thereof includes displaying the image on a display, a monitor, or the like, printing the image, transmitting the image to another user, and providing the image as a commercial product. The image as the commercial product includes a collage image generated by combining another image, a decoration, or the like, an edited image in which one or a plurality of images (image regions) are disposed in a predetermined layout, and a booklet consisting of a plurality of pages on which an image is posted, such as an album and a photo book. Further, the aspect of providing the image as the commercial product may include, in addition to the aspect of printing the image on a medium such as paper and providing the printed medium, an aspect of providing the image data (digital data) in a form of an electronic commercial product without printing the image on the medium. Further, the aspect of providing the printed image may include transmitting a medium, such as paper on which the image is printed, to a providing destination as a message card or a postcard. Further, a method of outputting the image may include posting and publishing the image to a social networking service (SNS).

In the first embodiment, a case where an output image including one input image Pi and a text Tx and not including the margin region described below is output will be described as an example. Further, in the first embodiment, as shown in FIG. 1, an image in which the text Tx is disposed in the input image Pi is output as the output image Po.

The text Tx is a text related to the input image Pi, and specifically, is character information indicating a content according to the subject in the input image. The text Tx corresponds to a comment and a message to the subject, a description of the subject, and a remark uttered by the subject. The text is configured of a phrase consisting of one or more words or a sentence. Further, in a case where the sentence is divided, each of a plurality of divided phrases may correspond to the text. Furthermore, the text may include a mimetic word, an onomatopoeia, an interjection, and the like.

In the first embodiment, the text Tx may be input by the user or may be automatically generated by the image processing apparatus. In a case where the text is automatically generated, the image processing apparatus analyzes the input image Pi to generate the text based on an analysis result. The analysis of the image means, for example, specifying a feature of the image. The feature of the image is information related to the image quality of each region of the image, a gradation value of pixels included in each region, and information on a subject estimated from these pieces of information. The information on the subject may include a type of the subject, a state of the subject, a position of the subject in the image, and a facial expression in a case where the subject is a person.

Further, it is desirable that the feature of the image can be digitized, vectorized, or tensorized. In this case, the analysis result of the image is the feature of the digitized, vectorized, or tensorized image, that is, a feature amount.

The subject means a person, an animal, an object, a background, and the like included in the image. Further, the concept of the subject may include a place appearing in the image, a scene (for example, dawn or dusk and fine weather), and a theme (for example, an event such as a trip, a meal, or a sports day). The image may be a landscape image, that is, the subject included in the image may be only a landscape, and the entire image may represent the landscape as the subject.

A technique for automatically generating the text from the analysis result of the image is not particularly limited. For example, as in the technique disclosed in JP2017-229102A, a correspondence relationship between the image analysis result and the content of the text may be stored as data, and the text corresponding to the image analysis result may be selected (generated) with reference to the correspondence relationship. Alternatively, a learning model for text generation may be constructed by performing machine learning, and the image may be input to the learning model to generate the text related to the image. The learning model described above specifies the feature of the input image to generate the text according to the feature. The learning model is constructed by performing the machine learning using, as learning data, an image acquired in the past and a text assigned to the image.

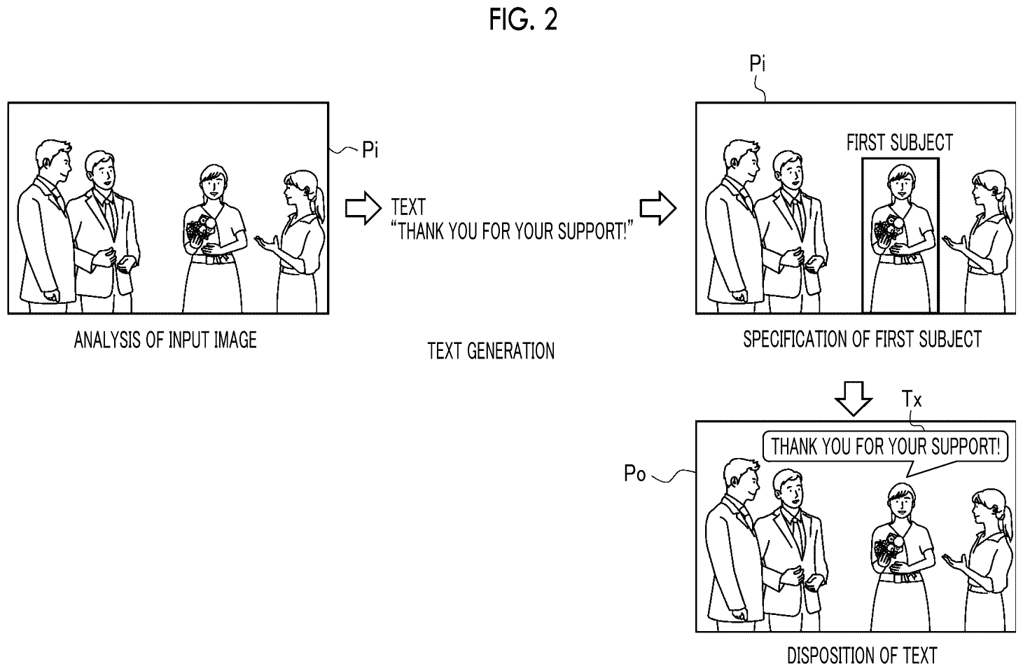

Further, in the first embodiment, the image processing apparatus disposes (assigns) the text Tx generated in the above manner at a position decided in accordance with the subject included in the input image Pi in the output image Po. Specifically, as shown in FIG. 2, the image processing apparatus analyzes the input image Pi to generate the text Tx, and then specifies a subject (hereinafter referred to as first subject) corresponding to the generated text Tx from the subject included in the input image Pi. The first subject is a subject having high relevance to the text Tx among one or more subjects included in the input image Pi. Specifically, the first subject corresponds to, for example, a subject that issues a voice of a content indicated by a text, a subject in a state indicated by a text, a subject that performs an operation indicated by a text, a subject that participates in an occurrence and an event indicated by a text, and the like.

As shown in FIG. 2, the image processing apparatus decides the disposition (strictly speaking, the disposition position) of the text Tx in the output image Po based on the input image Pi and the specified first subject, and outputs the output image Po in which the text Tx is disposed at the position.

As described above, the image processing apparatus of the first embodiment specifies the first subject corresponding to the generated text Tx within the input image Pi, and outputs the output image Po in which the text Tx is disposed at a position according to the specified first subject. Accordingly, it is possible to dispose the text Tx at an appropriate position in the output image Po in consideration of the subject (first subject) in the input image Pi.

Specifically, for example, it is possible to dispose the text at a position where the first subject and the text can be easily associated with each other, such as a periphery of the first subject. Such an effect is particularly effective in a case where a plurality of subjects are present in the input image. Specifically, it is possible to suppress the disposition of the text near the subject having a low relationship with the content of the text. Further, in the first embodiment, as described above, the disposition of the text is automatically decided by the function of the image processing apparatus. Therefore, the user does not need to decide the disposition of the text and the time and effort can be omitted.

A technique of specifying the subject (first subject) corresponding to the text to decide the disposition of the text in accordance with the specified first subject and the input image is not particularly limited. For example, a correspondence relationship between the content of the text, the disposition position of the text, and the first subject may be stored in advance as data, the first subject may be specified with reference to the correspondence relationship, and the disposition of the text may be decided to correspond to the first subject.

Alternatively, a learning model for position decision may be constructed by performing the machine learning and the image and the text may be input to the learning model to decide the disposition of the text in the image. With the learning model, the relevance between the input text and the subject in the input image is evaluated, and the first subject (specifically, position, range, and the like of the first subject in the image) is specified based on an evaluation result. Thereafter, the disposition of the text in the output image is decided according to the first subject based on a predetermined rule with the learning model. Such a learning model is constructed, for example, by performing the machine learning using, as learning data, an image without text acquired in the past and an image attached with text in which the text is disposed in association with the subject in the image.

Further, the machine learning may be performed stepwise. Specifically, first learning for constructing the learning model that specifies the first subject and second learning for constructing the learning model that decides the disposition of the text according to the first subject may be performed separately.

Furthermore, in the first learning, an Attention mechanism of deep learning may be applied to construct the learning model that specifies the first subject based on the process of generating the text with the learning model for text generation described above. In this case, in a case where the text to be assigned to the image is generated by using the learning model for text generation, it is possible to reflect, in a case where the first subject is specified, which analysis result of which region in the image is focused on to generate the text.

### Configuration Example of Image Processing Apparatus

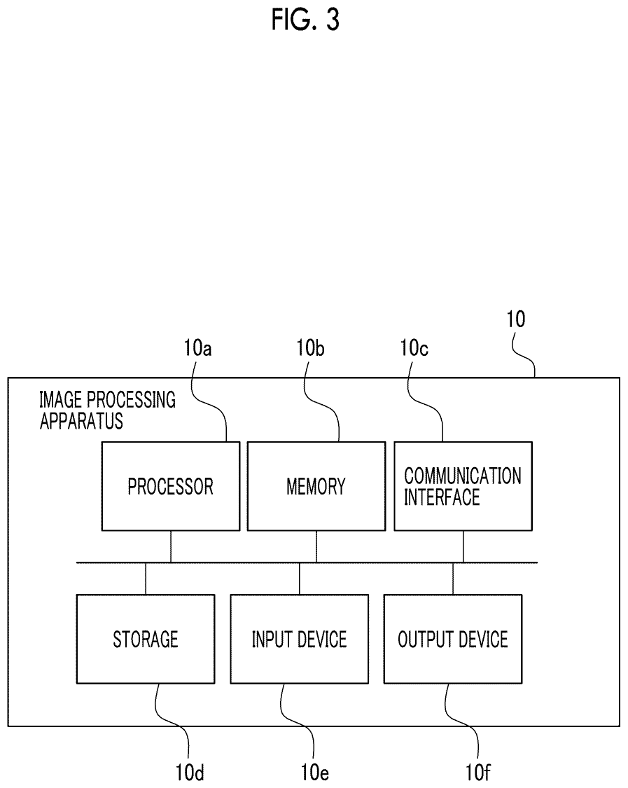

Next, a configuration example of the image processing apparatus (hereinafter image processing apparatus 10) according to the first embodiment will be described with reference to FIG. 3.

The image processing apparatus 10 is configured of a computer used by the user, specifically, a client terminal, and is specifically configured of a smartphone, a tablet terminal, a notebook personal computer (PC), or the like. The image processing apparatus 10 is not limited to the computer owned by the user, and may be configured of a terminal that is not owned by the user, such as a store-installed terminal, which is available by inputting a personal identification number, a password, or the like in a case where the user visits a store or the like, or by making a deposit or the like.

In the following, a case where the image processing apparatus 10 is configured of the computer owned by the user, specifically, the smartphone will be described as an example.

As shown in FIG. 3, the computer constituting the image processing apparatus 10 comprises a processor 10a, a memory 10b, a communication interface 10c, a storage 10d, an input device 10e, and an output device 10f.

The processor 10a is configured of, for example, a central processing unit (CPU), a micro-processing unit (MPU), a micro controller unit (MCU), a graphics processing unit (GPU), a digital signal processor (DSP), a tensor processing unit (TPU), or an application specific integrated circuit (ASIC).

The memory 10b is configured of, for example, a semiconductor memory such as a read only memory (ROM) and a random access memory (RAM).

The communication interface 10c may be configured of, for example, a network interface card or a communication interface board. The computer constituting the image processing apparatus 10 can communicate with other devices connected to the communication network, such as the Internet and a mobile communication line, via the communication interface 10c.

The storage 10d is configured of, for example, a flash memory, a hard disc drive (HDD), a solid state drive (SSD), a flexible disc (FD), a magneto-optical disc (MO disc), a compact disc (CD), a digital versatile disc (DVD), a secure digital card (SD card), a universal serial bus memory (USB memory), or the like.

The storage 10d may be built in a computer main body constituting the image processing apparatus 10, or may be attached to the computer main body in an external form. Alternatively, the storage 10d may be configured of a network attached storage (NAS) or the like. Further, the storage 10d may be an external device that can communicate with one computer constituting the image processing apparatus 10 through the communication network, such as an online storage or a database server.

The input device 10e is a device that receives an input operation of the user, and is configured of, for example, a touch panel or the like. Further, the input device 10e includes the imaging device, such as a smartphone built-in camera, and a microphone for sound collection.

The output device 10f is configured of, for example, a display.

Further, a program for an operating system (OS) and an application program for image processing execution are installed in the computer constituting the image processing apparatus 10 as software. These programs are read out and executed by the processor 10a to cause the computer constituting the image processing apparatus 10 to exert the functions and specifically, to execute a series of pieces of processing related to the output of the image including the text.

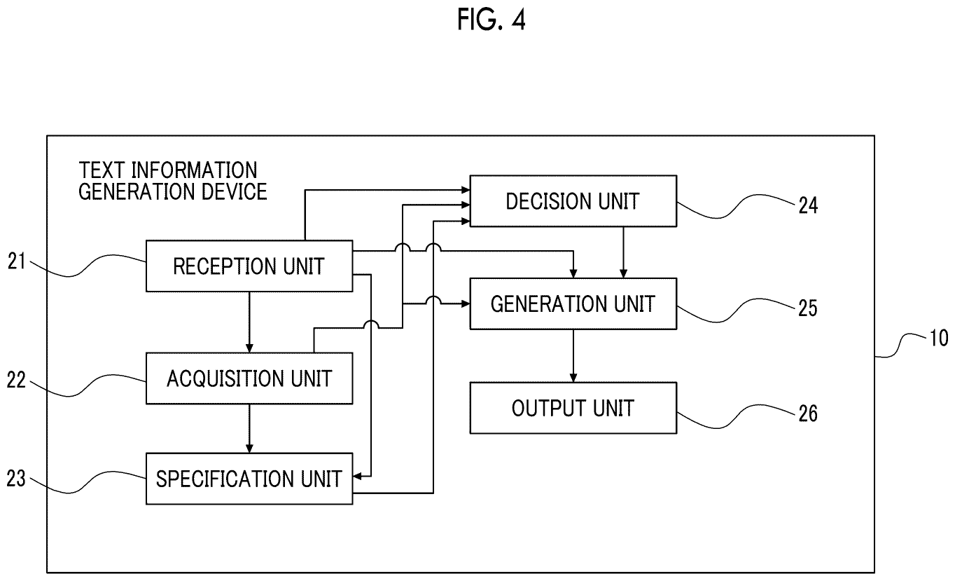

The configuration of the image processing apparatus 10 will be described again from the viewpoint of the function thereof with reference to FIG. 4. As shown in FIG. 4, the image processing apparatus 10 includes a reception unit 21, an acquisition unit 22, a specification unit 23, a decision unit 24, a generation unit 25, and an output unit 26. These functional units are realized by the processor 10a of the image processing apparatus 10 executing the application program for image processing described above and cooperating with another hardware device of the image processing apparatus 10. Further, some functions may be realized by using artificial intelligence (AI). Hereinafter, each functional unit will be described.

### Reception Unit

The reception unit 21 receives the input of the image to which the text is to be assigned. As described above, an input method of the image is not particularly limited. For example, the user may capture the subject within an angle of view by using the camera of the smartphone constituting the image processing apparatus 10. In this case, the image reception unit 21 receives the input of the image data of a captured image. Further, the reception unit 21 may download the data of the image from an external device (for example, server) through the network to receive the input of the image.

### Acquisition Unit

The acquisition unit 22 acquires the text Tx related to the image received by the reception unit 21, that is, the input image Pi. In the first embodiment, the acquisition unit 22 can acquire the text Tx by two methods.

A first acquisition method is to analyze the input image Pi and generate the text Tx based on the analysis result. Specifically, as described above, with reference to the data indicating the correspondence relationship between the image analysis result and the content of the text, the text Tx corresponding to the analysis result of the input image Pi may be selected (generated). Alternatively, the learning model for text generation constructed by the machine learning may be applied to the input image Pi to generate the text Tx related to the input image Pi.

Further, in a case where the text is generated in the first acquisition method, the acquisition unit 22 may generate the text Tx based on a region selected by the user in the input image Pi. More specifically, in a case where the text is generated based on the analysis result of the input image Pi, the acquisition unit 22 can set the region selected by the user in the input image Pi as a region-of-interest and generate the text Tx by focusing on the analysis result of the region-of-interest as compared with other regions. Accordingly, it is possible to reflect the intention of the user in generating the text Tx, and for example, it is possible to generate the text Tx by using a subject selected by the user as a target of the text assignment.

In this case, the user may select the region (region-of-interest) through the input device 10e. For example, the input image Pi may be displayed on a touch display of the smartphone constituting the image processing apparatus 10, and the user may touch the region-of-interest in the displayed input image Pi. A range selected as the region-of-interest may be randomly decided. One subject included in the input image Pi may be set as the region-of-interest, or a portion touched by the user in the input image may be set as the region-of-interest.

Further, the region-of-interest may be selected by the acquisition unit 22 (specifically, the processor 10a of the image processing apparatus 10 constituting the acquisition unit 22). That is, the acquisition unit 22 may analyze the input image Pi and select the region-of-interest based on the analysis result. In this case, the acquisition unit 22 may generate the text Tx based on the region-of-interest selected by the acquisition unit 22.

Further, in a case where the input image Pi is the captured image and accessory information is included in the image data of the captured image, the acquisition unit 22 may generate the text Tx based on the analysis result of the input image and the accessory information. The accessory information is various types of information related to the captured image, such as an imaging place, an imaging date and time, an imaging person, an imaging condition, and information about a camera used for imaging. The accessory information is, for example, tag information recorded in a format of an exchangeable image file format (Exif) in an image data file.

In a method of generating the text Tx based on the accessory information, for example, the machine learning is performed using, as learning data, the image acquired in the past, the accessory information of the image, and the text assigned to the image, and the learning model for text generation obtained as a result of the machine learning is used.

As described above, in the first embodiment, it is possible to generate the text Tx with reference to the accessory information of the input image together with the analysis result of the input image Pi. Accordingly, it is possible to generate a more appropriate text Tx based on the imaging place, the imaging date and time, and the like of the input image.

A second acquisition method is to acquire the text based on the input operation performed by the user through the input device 10e. Specifically, the acquisition unit 22 acquires the text Tx indicating the input content based on a character input performed by the user through the touch panel, voice input performed through a sound collection microphone, or the like. Accordingly, it is possible to acquire the text Tx according to the intention of the user and dispose (assign) the text Tx in the output image Po.

The acquisition unit 22 may acquire the text Tx by combining two or more of the text generation based on the analysis result of the input image Pi, the text generation based on the region-of-interest in the input image Pi, the text generation based on the accessory information, and the acquisition of the text input by the user.

### Specification Unit

The specification unit 23 specifies the first subject corresponding to the text Tx acquired by the acquisition unit 22 from the subject included in the input image Pi, and specifically specifies the position (coordinate position) and range of the first subject in the input image Pi. In the first embodiment, at least one subject of the person, the object, the animal, and the background is included in the input image Pi. The specification unit 23 specifies the first subject from the at least one subject.

In a case where the case shown in FIG. 2 is described as an example, the input image Pi including, as the subjects, a plurality of company employees participating in a farewell party is acquired, and a text “Thank you for your support” is generated from the feature obtained by analyzing the image. In this case, the company employee (person appearing in center portion of the input image Pi) who is seen off is specified as the first subject.

The first subject specified in one input image may be one or plural. In the following, unless otherwise specified, the first subject specified in one input image Pi is assumed to be one.

A method of specifying the first subject is not particularly limited as described above. For example, the first subject may be specified by referring to the data indicating the correspondence relationship between the text and the first subject. Alternatively, a learning model for subject specification, which is constructed by performing the machine learning, may be applied to the input image Pi and the acquired text Tx to specify the first subject corresponding to the text Tx. Further, the Attention mechanism of deep learning may be applied to the above learning model to specify the region (region-of-interest) in the input image Pi that is focused on in a case where the text is generated from the input image Pi, and the first subject may be specified based on the specified region-of-interest. Accordingly, it is possible to more appropriately specify the first subject corresponding to the text Tx.

### Decision Unit

The decision unit 24 decides the disposition (strictly speaking, disposition position) of the text Tx acquired by the acquisition unit 22 in the output image. In the first embodiment, the decision unit 24 decides the disposition of the text based on the input image and the first subject specified by the specification unit 23. More specifically, in the first embodiment, the disposition of the text in the input image is decided in the following manner.

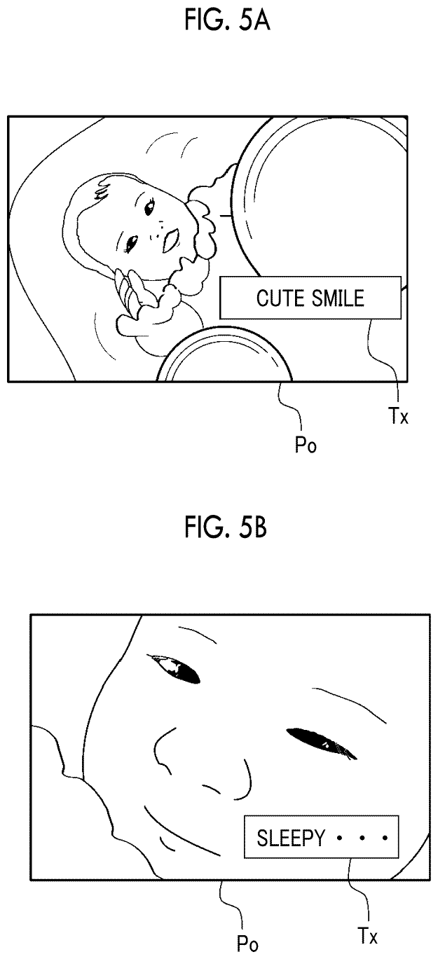

First, the decision unit 24 determines whether or not the text Tx can be disposed in the periphery of the first subject in the input image Pi such that the text Tx does not overlap with the first subject. In a case where the text Tx cannot be disposed so as not to overlap the first subject in the periphery of the first subject, the decision unit 24 decides the disposition of the text that overlaps the first subject. In this case, as shown in FIG. 5A, a disposition that does not overlap the specific portion of the first subject may be decided. The specific portion is a predetermined portion in the first subject, and is specifically a main portion in the first subject, and is a portion that is required to be clearly shown in the output image Po. For example, in a case where the first subject is a person, the specific portion is an upper body of the person, particularly, a face. In a case where the first subject is a person, the specific portion may be the whole body of the person. Further, in a case where the first subject is an object, the specific portion is a portion in which the object is difficult to identify in a case where the text overlaps with the object.

In a case where the specific portion is specified, a well-known technique can be used. Specifically, a technique (image analysis technique) of detecting a subject in an image may be applied to identify each portion of the subject in the image and specify which part each part is. Then, importance (priority) may be assigned to each of the specified portions according to a predetermined standard or rule, and the specific portion may be decided based on the importance (priority) assigned to each of the portions.

As described above, in a case where the text cannot be disposed so as not to overlap the first subject in the periphery of the first subject, the position not overlapping with the specific portion of the first subject is decided as the disposition position of the text. Accordingly, it is possible to avoid that the specific portion of the first subject is hidden and invisible by the text Tx.

In a case where it is difficult to dispose the text Tx so as not to overlap the specific portion of the first subject (for example, in a case where the input image is a zoom image of the face of the person who is the first subject), the decision unit 24 may decide the disposition of the text Tx to overlap with the specific portion. In this case, as shown in FIG. 5B, the disposition of the text Tx may be decided such that the influence of the text Tx on the specific portion is minimized. The disposition position of such a text Tx may be decided, for example, by using artificial intelligence (AI), or may be decided in accordance with a predetermined rule.

On the other hand, in a case where the text can be disposed so as not to overlap the first subject in the periphery of the first subject, the decision unit 24 determines whether or not the text can be disposed so as not to overlap both the first subject and a second subject in the periphery of the first subject in the input image. The second subject is a subject different from the first subject among the subjects included in the input image, and is a subject having lower relevance to the text than the first subject. Further, the second subject may be, for example, a subject of the same type (the same category) as the first subject. Specifically, in a case where one of a plurality of persons included in the input image as the subject is the first subject, the second subject is a person different from the first subject among the plurality of persons.

In a case where the text can be disposed so as not to overlap both the first subject and the second subject in the periphery of the first subject, the decision unit 24 decides the disposition of the text that does not overlap both the first subject and the second subject in the periphery of the first subject in the input image Pi, as shown in FIG. 5C. Accordingly, it is possible to dispose the text Tx at a position where the correspondence relationship with the first subject can be easily understood, and thus avoid that the first subject and the second subject are hidden and invisible by the text Tx.

In a case where the text Tx cannot be disposed so as not to overlap both the first subject and the second subject in the periphery of the first subject, the decision unit 24 decides the disposition of the text that overlaps the second subject but does not overlap the first subject in the periphery of the first subject in the input image Pi. Accordingly, it is possible to dispose the text Tx at a position where the correspondence relationship between the text Tx and the first subject can be easily understood.

Further, in a case where the user selects the region-of-interest in the input image Pi in acquiring the text, the decision unit 24 may decide the disposition of the text Tx according to the region selected by the user as the region-of-interest in deciding the disposition of the text Tx by the above manner. Specifically, the disposition of the text Tx may be decided near the region-of-interest selected by the user, or conversely, the disposition of the text Tx may be decided by avoiding the region-of-interest.

### Generation Unit

The generation unit 25 generates the output image Po according to the input image Pi based on the text Tx acquired by the acquisition unit 22 and the disposition of the text decided by the decision unit 24. The output image Po of the first embodiment is an image including the text Tx and the input image Pi, and specifically, is an image in which the text Tx is disposed (assigned) at the disposition decided by the decision unit 24 in the input image Pi, as shown in FIG. 1. More specifically, the generation unit 25 converts the text Tx into the text image and superimposes and disposes the text image on the input image Pi to generate the output image Po.

### Output Unit

The output unit 26 outputs the output image Po generated by the generation unit 25. The method of outputting the image is not particularly limited as described above. For example, the output image Po may be displayed on a display (output device 10f) of the computer constituting the image processing apparatus 10. Further, control data for printing the output image Po may be generated, and a printer (not shown) may be controlled based on the control data to print the output image Po by the printer. Alternatively, for the purpose of sharing the output image Po with another user, the image data of the output image Po may be transmitted from the computer constituting the image processing apparatus 10 to a terminal used by the other user. Alternatively, for the purpose of publishing the output image Po on the SNS, the image data of the output image Po may be uploaded to an SNS server.

### Example of Image Processing Method According to First Embodiment

Next, as an operation example of the image processing apparatus 10 according to the first embodiment, an image processing flow using the same device will be described. In the image processing flow described below, an image processing method according to the embodiment of the present invention is used. That is, each step in the image processing flow described below corresponds to a component of the image processing method according to the embodiment of the present invention.

The following flow is merely an example. Some steps in the flow may be deleted, a new step may be added to the flow, or an execution order of two steps in the flow may be exchanged, within a range not departing from the spirit of the present invention.

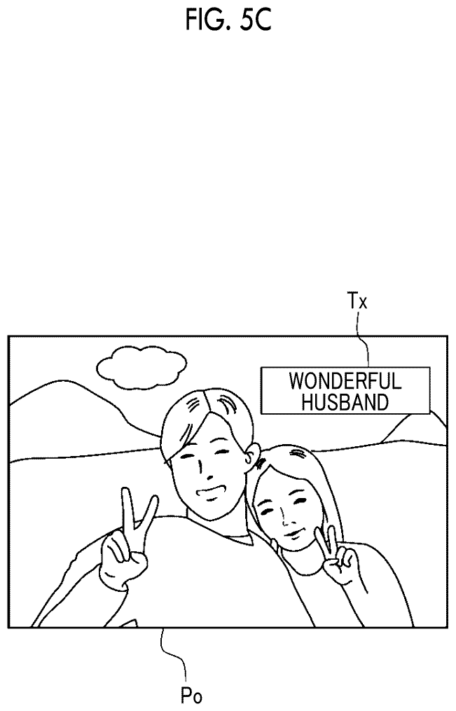

Each step in the image processing flow according to the first embodiment is implemented by the processor 10a provided in the image processing apparatus 10 in an order shown in FIG. 6. That is, in each step in the image processing flow, the processor 10a executes processing corresponding to each step in FIG. 6 among data processing defined in the application program for image processing.

Specifically, in the image processing flow according to the first embodiment, first, the processor 10a executes input reception processing (S001). In the input reception processing, the processor 10a receives the input of the image to which the text is assigned by the present flow, in other words, acquires the input image Pi to be processed.

Next, the processor 10a executes acquisition processing of acquiring the text Tx related to the input image Pi (S002). In the acquisition processing, the processor 10a may acquire the text based on the input operation of the text content by the user. Further, in the acquisition processing, the processor 10a may analyze the input image Pi and generate the text Tx based on the analysis result.

Further, in the acquisition processing, the user may be caused to select the region-of-interest in the input image Pi. In this case, in the acquisition processing, the processor 10a may generate the text Tx based on the region-of-interest selected by the user, and specifically by focusing on the analysis result of the region-of-interest as compared with the analysis result of a region other than the region-of-interest.

Further, in a case where the input image Pi is the captured image and the image data of the captured image includes the accessory information, such as the Exif tag, the processor 10a may generate the text Tx based on the analysis result of the input image Pi and the accessory information, in the acquisition processing.

Next, the processor 10a executes specification processing of specifying the first subject corresponding to the text Tx, which is acquired in the acquisition processing, from the subject included in the input image Pi (S003). The input image Pi includes at least one subject of the person, the object, the animal, and the background. In the specification processing, the processor 10a specifies the first subject from the at least one subject, and specifically specifies the position (coordinate position) and range of the first subject in the input image Pi.

Next, the processor 10a executes decision processing of deciding the disposition of the text Tx in the output image Po (S004). In the decision processing, the processor 10a decides the disposition of the text Tx based on the first subject specified in the specification processing.

Specifically, as the disposition of the text Tx, the processor 10a may decide the disposition that does not overlap the first subject in the periphery of the first subject in the input image Pi. In this case, the disposition of the text Tx that does not overlap the specific portion (for example, the face of the person) of the first subject may be decided in the periphery of the first subject. Further, as the disposition of the text Tx, the processor 10a may decide the disposition that does not overlap both of the first subject and the second subject in the periphery of the first subject in the input image Pi.

Next, the processor 10a executes generation processing of generating the output image Po according to the input image Pi (S005). In the generation processing, the processor 10a assigns the text Tx, which is acquired in the acquisition processing, to the disposition decided in the decision processing in the input image Pi to generate the output image Po.

Thereafter, the processor 10a executes output processing of outputting the generated output image Po (S006). With the execution of the output processing, the output image Po configured with the input image Pi in which the text Tx is disposed in the image is output. Specifically, for example, the output image Po is displayed on the display or the like, or printed by the printer, or the image data of the output image is transmitted for the purpose of publishing or sharing.

The image processing flow according to the first embodiment ends at a point in time at which the series of pieces of processing described above ends. In a case where the input image is received, the image processing flow is implemented each time the input image Pi is received. That is, the series of pieces of processing described above is repeatedly executed by the processor 10a each time a new input image Pi is received.

### Modification Example of First Embodiment

The first embodiment of the present invention is not limited to the above embodiment, and for example, the following modification examples may be considered. Hereinafter, the modification examples thereof will be described. In the following, differences between the modification examples and the first embodiment described above will be described.

### About First Modification Example

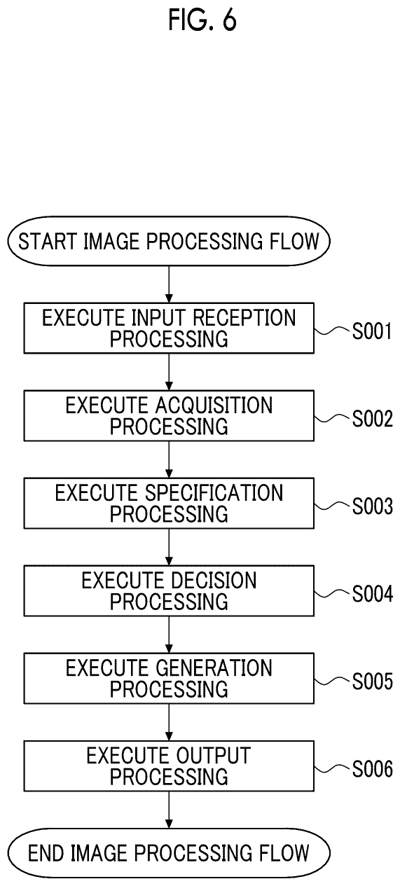

In the first embodiment described above, the image processing apparatus 10 acquires one text Tx for one input image Pi, in other words, one output image Po includes one text Tx. However, the present invention is not limited thereto. As the modification example of the first embodiment, a plurality of texts Tx may be acquired for one input image Pi. That is, as one embodiment of the present invention, as shown in FIG. 7, an embodiment (hereinafter referred to as first A embodiment) may be considered in which the plurality of texts Tx are assigned to one input image Pi to generate the output image Po.

In the first A embodiment, an example of a method of acquiring the plurality of texts Tx related to one input image Pi includes a method of constructing, in a specification in which the plurality of texts Tx can be output, a learning model (text generation model) that analyzes the input image Pi to generate the text Tx. That is, the text generation model that generates the plurality of texts from one input image Pi may be constructed by the machine learning, and the plurality of texts Tx may be acquired using the model. The number of texts Tx generated by using the text generation model may be designated by the user or may be automatically set on a side of the model according to the content (subject) of the input image Pi.

Further, the text generation model may present a plurality of candidates for the text Tx based on the analysis result of the input image Pi (specifically, the feature amount of the input image). Two or more candidates selected by the user may be employed (acquired) as the plurality of texts Tx from the plurality of presented candidates for the text. In this case, the text generation model may evaluate the validity (likelihood) as the text for each of the plurality of presented candidates for the text and present an evaluation value thereof together with the candidate. This evaluation value corresponds to, for example, an output probability (certainty as candidate) calculated by applying a softmax function to the candidate output by the learning model. The user may select the two or more candidates based on the evaluation value of the validity calculated for each candidate. Further, among the plurality of candidates, a candidate whose evaluation value is in a top n-th (n is a natural number of 2 or more) may be automatically selected.

Further, an example of another method of acquiring the plurality of texts related to one input image includes a method of dividing a text consisting of one sentence into a plurality of phrases. That is, the plurality of phrases obtained by segmenting and separating one text may be acquired as the plurality of texts Tx. For example, the text acquired (generated) in the acquisition processing described above is assumed to be “July 21st, Happy birthday!!”. In this case, as shown in FIG. 7, the above text is divided into two texts “July 21st” and “Happy birthday!!”. In this manner, it is possible to divide a relatively long text into a plurality of shorter texts and assign each of the divided texts to the input image Pi.

As described above, in the first A embodiment, the plurality of texts Tx are acquired for one input image Pi. In this case, the processor 10a of the image processing apparatus 10 specifies, for each of the plurality of texts Tx, the first subject in the input image Pi and decides the disposition of the text in the output image Po. In this case, the processor 10a (specifically, the decision unit 24) may decide, for each of the plurality of texts Tx, the disposition in which the texts do not overlap each other in the periphery of the first subject (girl in FIG. 7) as shown in FIG. 7. Accordingly, it is possible to avoid that the texts overlap each other and each text Tx is difficult to be viewed while utilization value of the output image Po is enhanced by assigning the plurality of texts Tx.

The first subject specified for each of the plurality of texts Tx may be the same between the texts or may be different between the texts.

### About Second Modification Example

In the first embodiment described above, in a case where the disposition of the text Tx in the output image Po is decided, the disposition is decided based on a presence region of the subject in the input image Pi. Specifically, the disposition of the text Tx is decided in the region that does not overlap the first subject, the region that does not overlap the specific portion of the first subject, or the region that does not overlap both the first subject and the second subject, in the periphery of the first subject in the input image Pi. In this case, suitability or unsuitability of a plurality of regions in the input image Pi as the region in which the text Tx is disposed may be evaluated, and the disposition of the text Tx may be decided based on the evaluation result. In other words, as one embodiment of the present invention, an embodiment (hereinafter referred to as first B embodiment) may be considered in which evaluation values based on the analysis results of the input image Pi are acquired for the plurality of regions in the input image and the disposition of the text is decided based on the evaluation value of each region.

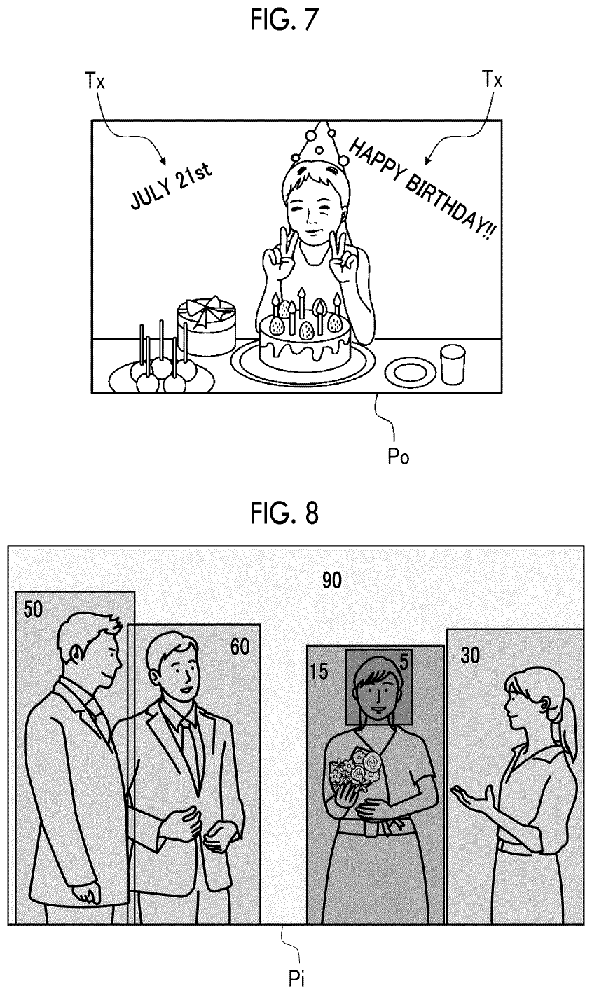

A method of acquiring the evaluation value for the plurality of regions in the input image is not particularly limited. Specifically, in the method of acquiring the evaluation value, the subject in the input image is detected by using a well-known subject detection technique and segmentation technique. In a case where the plurality of subjects are detected, the input image Pi is divided into the plurality of regions according to the plurality of subjects, as shown in FIG. 8. Further, in a case where a person is included in the plurality of subjects, a face (particularly, front face) is extracted, for a region in which the person is present, by applying a well-known face extraction technique, and a region including the face is specified.

As shown in FIG. 8, for each of the plurality of regions, the evaluation value (numerical value attached to each region in the image in FIG. 8) is calculated and acquired based on the relevance between the subject included in each region and the acquired text Tx. The evaluation value relates to the disposition of the text Tx, and specifically, is a score related to the suitability of the region where the text Tx is disposed. The score may be smaller as the relevance to the text Tx is higher, or conversely, may be larger as the relevance to the text Tx is higher. Further, for a region in which a person having high relevance to the text Tx is present, the evaluation value to be assigned to the region (face region) in which the face of the person is present may be set to a value in a case where the relevance is higher than the evaluation value to be assigned to a region other than the face region, as shown in FIG. 8.

In a case where the relevance between each region in the input image Pi and the text Tx is evaluated, the learning model used in a case where the text is generated may be applied. Specifically, for each region of the input image, a degree of focusing on the region in a case where the text is generated may be estimated, the relevance to the text Tx may be evaluated based on the estimated degree of focusing, and the evaluation value may be assigned to the region.

Further, as another example of the method of assigning the evaluation value, the evaluation value may be assigned in accordance with the importance of the subject included in each region, regardless of the relevance to the text Tx. Specifically, the input image Pi is analyzed by the same procedure as described above to detect the subject in the input image Pi, and the importance is set for each subject in a case where the plurality of subjects are detected. The importance is set in accordance with a predetermined rule. For example, a correspondence relationship between a type and the importance of the subject is decided in advance for each type of the subject, and the importance is set based on the correspondence relationship. For the plurality of regions in the input image Pi, evaluation values according to the importance of the region are acquired (calculated). In this case, the evaluation value may be larger as the importance is higher, or conversely, may be smaller as the importance is higher. Further, for the region in which the subject (for example, person) having high importance is present, the evaluation value to be assigned to the region (face region) in which the face of the person is present may be set to a value in a case where the importance is high as compared with the evaluation value to be assigned to the region other than the face region.

The processor 10a (specifically, decision unit 24) of the image processing apparatus 10 decides the disposition of the texts Tx based on the evaluation value acquired for each region in the input image Pi. Specifically, for example, in a case where the evaluation value is smaller as the importance of the subject is higher, the disposition of the text Tx is decided in a region where the evaluation value is high.

As described above, in the first B embodiment, the processor 10a of the image processing apparatus 10 decides the disposition of the text based on the evaluation values acquired for the plurality of regions in the input image Pi. Accordingly, it is possible to appropriately decide the disposition of the text Tx based on the relevance between each subject and the text Tx or the importance of each subject.

More specifically, in the first B embodiment, the evaluation value for each region in the input image Pi is acquired such that a possibility that the disposition of the text Tx is decided in a target region in the input image Pi is lower than a possibility that the disposition of the text Tx is decided in a region other than the target region. Accordingly, in the output image Po, it is possible to dispose the text Tx at a position that does not overlap the target region in the input image Pi included in the output image Po. The target region is a region in the input image Pi, which is required to avoid overlapping with the text Tx. Specifically, for example, a region in which a subject having high importance is present, particularly, a region in which a face of the person is positioned, in a case where such a subject is a person, corresponds to the target region.

### Second Embodiment of Present Invention

In the first embodiment described above, one input image Pi is acquired, but a case may be considered in which a plurality of input images Pi are acquired. This case will be described as a second embodiment of the present invention (hereinafter second embodiment).

In the second embodiment, main differences from the first embodiment will be described, and common points with the first embodiment will not be described.

In the second embodiment, the processor 10a of the image processing apparatus 10 acquires a plurality of images as the input image Pi. A procedure of the image acquisition is the same as that of the first embodiment. The processor 10a analyzes the plurality of input images Pi to generate the text Tx related to at least one of the plurality of input images Pi based on an analysis result of the plurality of input images Pi.

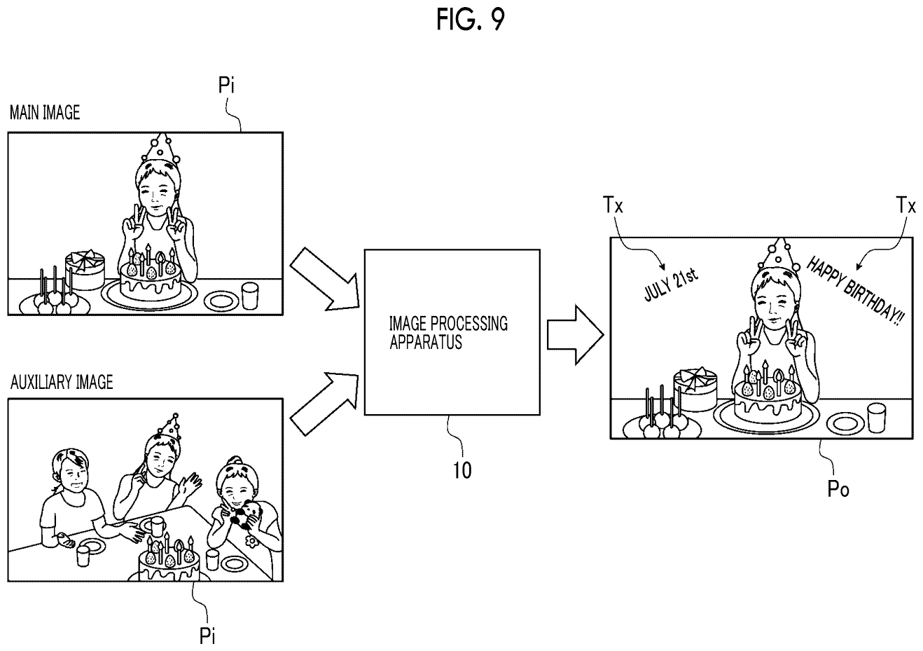

Specifically, as shown in FIG. 9, in a case where two or more input images Pi are input, one input image Pi is a main image to be subjected to the text assignment, and remaining input images Pi are auxiliary images for text generation. The processor 10a analyzes each of the main image and the auxiliary image to generate the text Tx for the main image based on the analysis result of each image. A text generation procedure is the same as that of the first embodiment except that the analysis results of the plurality of images are used.

After the generation of the text Tx, the processor 10a specifies the first subject corresponding to the generated text Tx from the subject included in the main image. A procedure of specifying the first subject is the same as that of the first embodiment.

The processor 10a decides the disposition of the text Tx in the output image Po including the main image based on the specified first subject. In this case, as shown in FIG. 9, the disposition of the text Tx is preferably decided in a region that does not overlap the first subject in the periphery of the first subject in the main image, particularly, in a region that does not overlap a specific portion of the first subject. A procedure of deciding the disposition of the text Tx is the same as that of the first embodiment.

Further, the second embodiment is not limited to the case where the text to be assigned to the main image is generated based on the plurality of input images Pi including the main image. For example, the processor 10a of the image processing apparatus 10 may simultaneously receive m (m is natural number) input images Pi related to each other, and generate the text Tx related to each input image Pi by the number of input images Pi based on the analysis result of each of the m input images Pi. That is, one text Tx may be assigned to each of the m input images Pi.

An example of the m input images Pi related to each other may include images captured at the same imaging place and the same imaging time, or may be images captured on the same imaging theme (specifically, images obtained by imaging the same subject a plurality of times by changing imaging time).

Further, the second embodiment may include a case where processing of generating the text Tx and processing of deciding the disposition of the text Tx are repeatedly executed each time the input image Pi is acquired (received). In this case, the text Tx is assigned to the acquired input image Pi for each input image.

As described above, in the second embodiment, it is possible to generate the text Tx based on the analysis results of the plurality of input images Pi. In a case where an album or a photo book is created, such an effect is particularly effective in a case where the text is assigned to at least one or more images among a plurality of images included in the album or the photo book.

In the second embodiment, in a case where the plurality of input images Pi are analyzed to acquire the text, there is no need to use all of the plurality of input images Pi, and the plurality of input images Pi may include an input image Pi that is not analyzed (input image Pi that is out of analysis target).

### Third Embodiment of Present Invention

In the first embodiment described above, the image including the subject, strictly speaking, the image consisting of only the image region including the subject is used as the input image Pi.

On the other hand, as shown in FIG. 10, a case may be considered in which an edited image generated by disposing one or more images (material images) on an image for layout, that is, an image having an image region and a margin region is used as the input image Pi. This case will be described as a third embodiment of the present invention (hereinafter third embodiment).

In the third embodiment, main differences from the first embodiment will be described, and common points with the first embodiment will not be described.

As described above, the input image Pi in the third embodiment is an image having an image region Pa1 and a margin region Pa2, and is generated, for example, by using image editing software or the like. The image region Pa1 is an image including the subject, and one or a plurality of image regions Pa1 are disposed in the input image Pi. The blank region Pa2 is a region positioned outside the image region Pa1 in the input image Pi, and may be a plain region or may be a region to which a color pattern, a design, or the like is added.

In the following, as shown in FIG. 11, a case where the plurality of image regions Pa1 are included in the input image Pi and the blank region Pa2 is a white and plain region will be described as an example.

In the third embodiment, an output image including the input image Pi and the text Tx is output. Specifically, the processor 10a of the image processing apparatus 10 (hereinafter image processing apparatus 10X) according to the third embodiment decides the disposition of text Tx in the margin area Pa2 in the input image Pi included in the output image Po, as can be seen in FIG. 11. More specifically, the processor 10a analyzes the input image Pi in the above manner, strictly speaking, analyzes the plurality of image regions Pa1 included in the input image Pi to generate one or more texts Tx based on each analysis result.

After the generation of the text Tx, the processor 10a specifies the first subject corresponding to the generated text Tx from respective subjects of the plurality of image regions Pa1 included in the input image Pi. The processor 10a decides the disposition of the text Tx based on the specified first subject and the input image Pi. In this case, for example, the processor 10a specifies the image region Pa1 including the first subject among the plurality of image regions Pa1 included in the input image Pi to decide the disposition of the text Tx in the margin region Pa2 adjacent to the image region Pa1.

Finally, as shown in FIG. 11, the processor 10a generates the output image Po in which the text is disposed in the margin region Pa2, and outputs the generated output image Po. As described above, in the third exemplary embodiment, in a case where the input image Pi includes the margin region Pa2, with the disposition of the text Tx by effectively using the margin region Pa2, it is possible to generate an edited image with text (output image Po). Such an effect is particularly effective in a case where the text is assigned to an image constituting each page of a postcard or a photo book.

Further, the effect of the third embodiment is useful even in a case where the text Tx is difficult to be disposed in the image region Pa1, such as a case where the face of the person who is the subject is zoomed in over the entire image region Pa1.

In the third embodiment, the text Tx may be disposed in the image region Pa1 of the input image Pi. That is, in the third embodiment, the disposition of the text Tx may be decided in at least one of the image region Pa1 or the margin region Pa2 of the input image Pi.

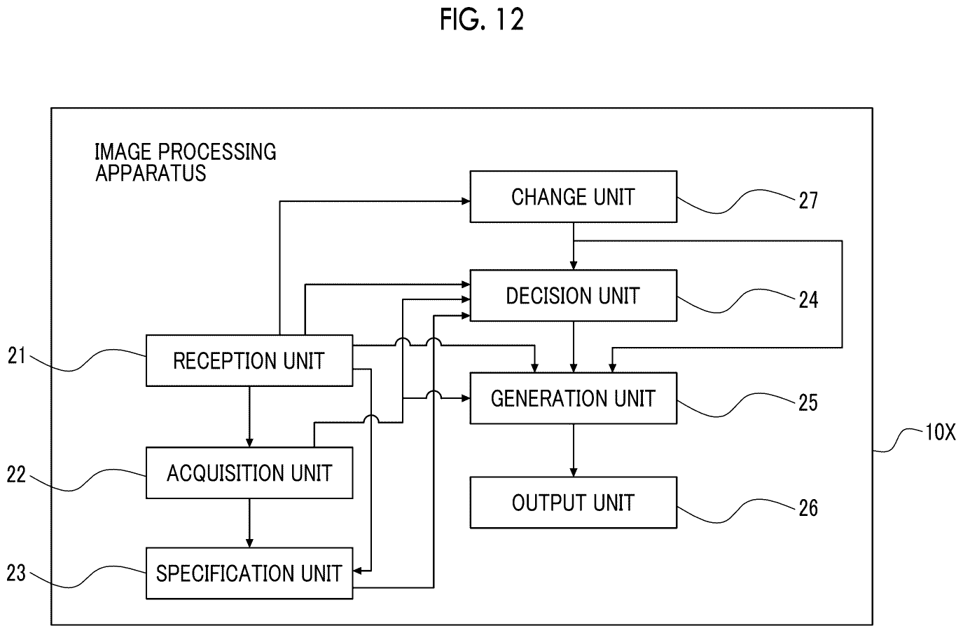

Further, in the third embodiment, as shown in FIG. 12, the image processing apparatus 10X may further comprise a change unit 27 in addition to the above functions. The change unit 27 is a function of changing a layout of the image region Pa1 in the input image Pi. The layout of the image region Pa1 may include the number of image regions Pa1 disposed in the input image Pi, a size, disposition position, outer edge shape (aspect ratio) of each image region Pa1, an inclination of the image region Pa1 with respect to the input image Pi (that is, rotation amount of image region Pa1), and the like.

In a case where the function of the change unit 27 is used, in a previous stage thereof, the processor 10a acquires the text Tx related to the input image Pi and generates the text Tx based on the analysis result of each image region Pa1 in the input image Pi, for example. In a subsequent step, the change unit 27 determines, based on the generated text Tx, whether or not the disposition of the generated text Tx can be decided in the margin region Pa2 in the input image Pi.

Specifically, the change unit 27 specifies the number of characters, size, and the like of the generated text Tx, and specifies the position, size, and the like of the blank region Pa2 adjacent to the image region Pa1 including the first subject corresponding to the text Tx in the input image Pi (hereinafter referred to as adjacent blank region). In this case, the change unit 27 may specify whether or not the adjacent margin region is present in the input image Pi at the present point in time. Based on the specific result, the change unit 27 determines whether or not the text Tx can be disposed in the margin region Pa2, specifically, the adjacent margin region in the input image Pi at the present point in time.

In a case where the disposition of the text can be decided in the adjacent margin region in the input image Pi at the present point in time, the processor 10a (specifically, decision unit 24) decides the disposition of the text Tx in the adjacent margin region.

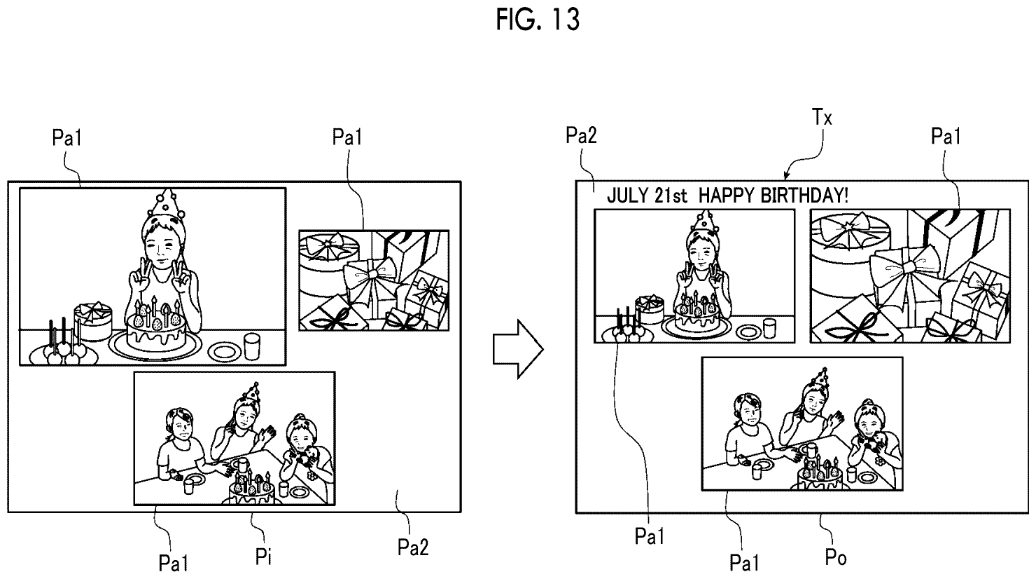

On the other hand, in a case where the disposition of the text Tx cannot be decided in the adjacent margin region in the input image Pi at the present point in time, or in a case where the adjacent margin region is not present, the change unit 27 changes the layout of the image region Pa1 in the input image Pi as shown in FIG. 13. The change of the layout may include changing the number and disposition of the image regions Pa1 in the input image Pi and implementation of movement, expansion or reduction, aspect ratio change, trimming, and the like of one or more image regions Pa1.

The layout may be automatically changed in accordance with a preset rule, or may be changed based on a change operation of the user. Alternatively, with the use of artificial intelligence (AI), a layout in which the adjacent margin region sufficient for disposing the text Tx is secured may be found, the input image Pi may be edited again in the layout, and the position, size, and the like of the image region Pa1 in the input image Pi may be changed.

In a case where the change unit 27 changes the layout of the image region Pa1 in the input image Pi, the processor 10a (specifically, decision unit 24) decides the disposition of the text Tx in the output image Po including the input image Pi whose layout is changed. In this case, as shown in FIG. 13, the processor 10a decides the disposition of the text Tx in the margin region Pa2, strictly speaking, in the adjacent margin region in the input image Pi whose layout is changed, in the output image Po.

With the above configuration, in a case where the layout of the image region Pa1 in the input image Pi is a layout in which the text Tx cannot be disposed in the adjacent margin region, it is possible to appropriately review the layout such that the text Tx can be disposed in the adjacent margin region.

### Other Embodiments

Although the specific embodiment of the present invention has been described above, the above embodiment is merely an example for ease of understanding of the present invention, and is not intended to limit the present invention. That is, the present invention may be changed or improved from the embodiment described below without departing from the spirit of the present invention. Further, the present invention includes an equivalent thereof. Furthermore, the embodiment of the present invention can include a form in which the above embodiment and one or more of the following modification examples are combined.

### Modification Example of Output Image

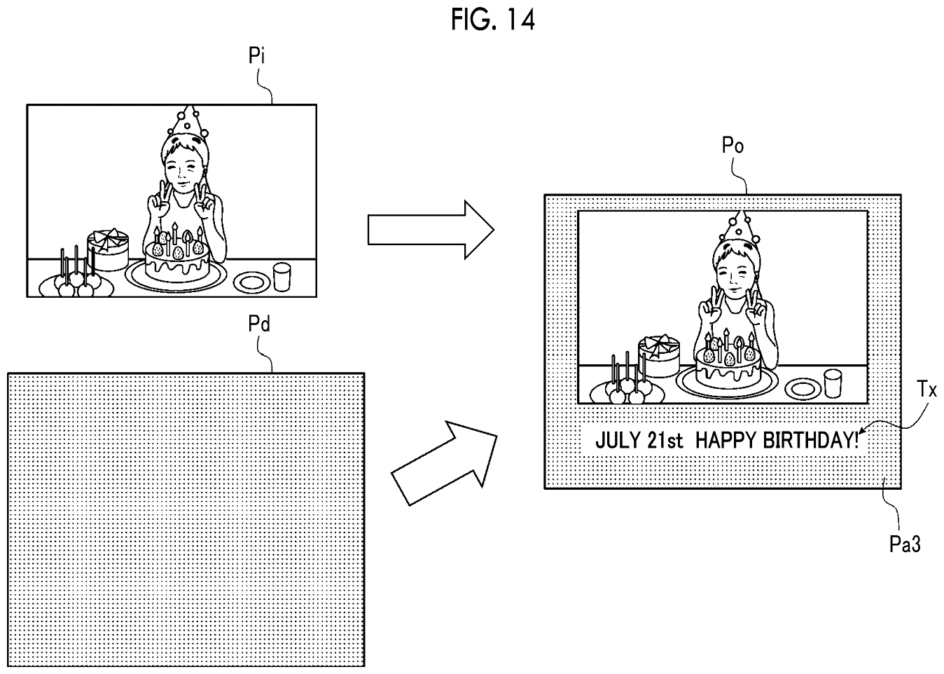

In the above embodiment, the text Tx is assigned to the input image Pi to generate the output image Po. That is, the output image Po according to the above embodiment is the same image as the input image Pi except that the text Tx is assigned. However, the present invention is not limited thereto. As shown in FIG. 14, the output image Po may include the input image Pi and the text Tx and may have a margin region Pa3 in at least a part of the periphery of the input image Pi in the output image Po.

In a case where the output image Po is obtained, the processor 10a of the image processing apparatus 10 receives the input of the image, acquires the text Tx related to the input image Pi, and specifies the first subject from the subject in the input image Pi, in the same procedure as in the embodiment described above. Further, as shown in FIG. 14, an image (hereinafter mounting board image Pd) to be used as a mounting board for pasting the input image Pi is selected.

The mounting board image Pd is an image having a larger display size (angle of view) than the input image Pi, and constitutes the output image Po together with the input image Pi and the text Tx (strictly speaking, image of text Tx). Specifically, the input image Pi is combined with the text Tx such that these images are disposed (superimposed) on the mounting board image Pd to generate the output image Po. Further, as described above, since the mounting board image Pd has a larger display size than the input image Pi, a region in which the input image Pi is not disposed, in the mounting board image Pd included in the output image Po, is the margin region Pa3 as shown in FIG. 14.

Moreover, in generating the output image Po, the processor 10a of the image processing apparatus 10 decides the dispositions of the input image Pi and the text Tx in the output image Po. The disposition of the input image Pi may be decided in accordance with the input operation of the user, or may be automatically decided by the processor 10a according to the content of the input image Pi (specifically, subject in input image Pi). The disposition of the text Tx is decided based on the first subject specified in the input image Pi, and is decided, for example, such that the text Tx does not overlap the first subject or the specific portion of the first subject in the periphery of the first subject. In this case, the disposition of the text Tx may be decided in at least one region of a region in which the input image Pi is disposed or the margin region Pa3, in the output image Po.

### About Computer Constituting Image Processing Apparatus

In the above embodiment, the image processing apparatus according to the embodiment of the present invention is configured by a computer that is directly used by the user, such as a terminal (client terminal) owned by the user. However, the present invention is not limited thereto. The image processing apparatus according to the embodiment of the present invention may be configured of a computer that can be indirectly used by the user, for example, a server computer. The server computer may be, for example, a server computer for a cloud service, specifically, a server computer for an application service provider (ASP), software as a service (SaaS), platform as a service (PaaS), or infrastructure as a service (IaaS). In this case, in a case where necessary information is input to the client terminal, the server computer performs various types of processing (calculation) based on the input information, and a calculation result is output to a client terminal side. That is, it is possible to use the function of the server computer constituting the image processing apparatus according to the embodiment of the present invention on the client terminal side.

### About Configuration of Processor

The processor provided in the image processing apparatus according to the embodiment of the present invention includes various processors. Examples of the various processors include a CPU that is a general-purpose processor that executes software (program) and functions as various processing units.

Moreover, various processors include a programmable logic device (PLD), which is a processor of which a circuit configuration can be changed after manufacturing, such as a field programmable gate array (FPGA).

Furthermore, the various processors include a dedicated electric circuit that is a processor having a circuit configuration specially designed for executing a specific process, such as an application specific integrated circuit (ASIC).

Further, one functional unit of the image processing apparatus according to the embodiment of the present invention may be configured of one of the various processors described above. Alternatively, one functional unit of the image processing apparatus according to the embodiment of the present invention may be configured of a combination of two or more processors of the same type or different types, for example, a combination of a plurality of FPGAs or a combination of an FPGA and a CPU.

Further, a plurality of functional units of the image processing apparatus according to the embodiment of the present invention may be configured of one of the various processors, or two or more of the plurality of functional units may be configured of one processor.

Further, as in the above embodiment, a form may be employed in which one processor is configured of a combination of one or more CPUs and software, and the processor functions as the plurality of functional units.

Further, for example, as represented by a system on chip (SoC) or the like, a form may be employed in which a processor that realizes the functions of the entire system including the plurality of functional units in the image processing apparatus according to the embodiment of the present invention with one integrated circuit (IC) chip is used. Further, a hardware configuration of the various processors described above may be an electric circuit (circuitry) in which circuit elements, such as semiconductor elements, are combined.

### EXPLANATION OF REFERENCES

10, 10X: image processing apparatus
10a: processor
10b: memory
10c: communication interface
10d: storage
10e: input device
10f: output device
21: reception unit
22: acquisition unit
23: specification unit
24: decision unit
25: generation unit
26: output unit
27: change unit
Pa1: image region
Pa2, Pa3: margin region
Pd: mounting board image
Pi: input image
Po: output Image
Tx: text

What is claimed is:

1. An image processing apparatus that processes an input image, the image processing apparatus comprising:
a processor,
wherein the processor is configured to execute:
processing of acquiring a text related to the input image;
processing of specifying a first subject corresponding to the text from a subject included in the input image; and
processing of deciding a disposition of the text in an output image based on the input image according to the input image and the first subject.

2. The image processing apparatus according to claim 1,
wherein the processor is configured to acquire the text based on an input operation of a user.

3. The image processing apparatus according to claim 1,
wherein the processor is configured to generate the text based on a region selected by a user in the input image.

4. The image processing apparatus according to claim 1,
wherein the processor is configured to generate the text based on an analysis result of the input image.

5. The image processing apparatus according to claim 1,
wherein the processor is configured to generate the text based on accessory information of the input image.

6. The image processing apparatus according to claim 1,
wherein the processor is configured to decide the disposition in which the text does not overlap the first subject.

7. The image processing apparatus according to claim 1,
wherein the processor is configured to decide the disposition in which the text does not overlap a specific portion of the first subject.

8. The image processing apparatus according to claim 1,
wherein, in a case where the output image including the input image and the text is output, the processor is configured to decide the disposition in which the text does not overlap the first subject and a second subject different from the first subject in the input image, in a periphery of the first subject.

9. The image processing apparatus according to claim 1,
wherein, in a case where a plurality of texts are acquired as the text, the processor is configured to decide the disposition of the plurality of texts in which the texts do not overlap each other in a periphery of the first subject.

10. The image processing apparatus according to claim 1,
wherein, in a case where the output image including the input image having an image region and a margin region and the text is output, the processor is configured to decide the disposition in at least one of the image region or the margin region of the input image included in the output image.

11. The image processing apparatus according to claim 1,
wherein, in a case where the output image including the input image and the text is output, the processor is configured to generate a margin region in at least a part of a periphery of the input image in the output image, and decide the disposition of the input image and the text in the output image.

12. The image processing apparatus according to claim 1,
wherein the processor is configured to:
acquire evaluation values related to the dispositions for a plurality of regions in the input image based on the input image; and
decide the dispositions based on the evaluation values of the plurality of regions.

13. The image processing apparatus according to claim 1,
wherein the processor is configured to acquire a plurality of texts as the text, and decide the disposition for the plurality of texts.

14. The image processing apparatus according to claim 1,
wherein the processor is configured to divide the text into a plurality of texts, and decide the disposition for the plurality of texts.

15. The image processing apparatus according to claim 1,
wherein the processor is configured to:
acquire a plurality of input images as the input image; and
generate the text related to at least one of the plurality of input images based on analysis results of the plurality of input images.

16. The image processing apparatus according to claim 1,
wherein, in a case where the output image including the input image having an image region and a margin region and the text is output, the processor is configured to:
determine whether or not the disposition is capable of being decided in the margin region in the input image based on the text;
change a layout of the image region in the input image in a case where the disposition is determined to be incapable of being decided in the margin region in the input image; and
decide the disposition in the margin region in the output image including the input image whose layout is changed.

17. An image processing method of processing an input image by a processor, the image processing method comprising: by the processor,
a step of acquiring a text related to the input image;
a step of specifying a first subject corresponding to the text from a subject included in the input image; and
a step of deciding a disposition of the text in an output image based on the input image according to the input image and the first subject.

18. The image processing method according to claim 17,
wherein, in the step of acquiring the text, the text is generated based on an analysis result of the input image, by the processor.

19. The image processing method according to claim 18, further comprising:
a step of assigning evaluation values related to the dispositions to a plurality of regions in the input image by the processor,
wherein, in the step of deciding the disposition, the disposition is decided based on the evaluation values of the plurality of regions by the processor.

20. A computer-readable recording medium on which a program for causing a computer to execute each of the steps included in the image processing method according to claim 17 is recorded.
